(19) United States
(12) Patent Application Publication
(10) Pub. No.: US 2020/0247415 A1
(43) Pub. Date: Aug. 6, 2020

(54) VEHICLE, AND CONTROL APPARATUS AND CONTROL METHOD THEREOF

(71) Applicant: HONDA MOTOR CO., LTD., Tokyo (JP)

(72) Inventors: Kanta TSUJI, Wako-shi (JP); Atsushi ISHIOKA, Wako-shi (JP)

(21) Appl. No.: 16/774,174

(22) Filed: Jan. 28, 2020

(30) Foreign Application Priority Data
Feb. 5, 2019 (JP) 2019-018823

(51) Int. Cl. B60W 30/18; B60W 50/10; G01C 21/34; G05D 1/02

(52) U.S. Cl. CPC B60W 30/18163; G05D 1/0223; G01C 21/3492; B60W 50/10

(57) ABSTRACT

A control apparatus of a vehicle is provided. The apparatus includes a recognition unit configured to recognize a travel environment of the vehicle, a generation unit configured to generate a travel plan based on the travel environment, and a control unit configured to perform, based on the travel plan, travel control including at least one of acceleration/deceleration and/or steering of the vehicle. In a case in which a lane change operation is to be performed, the control unit decides a lane change difficulty degree or a degree of automation of travel control in the current environment, selects, based on the decided difficulty degree or degree of automation, one lane change mode among lane change modes with different degrees of participation by a driver, and performs the travel control in accordance with the selected mode.

### CROSS-REFERENCE TO RELATED APPLICATION

This application claims priority to and the benefit of Japanese Patent Application No. 2019-018823 filed on Feb. 5, 2019, the entire disclosure of which is incorporated herein by reference.

### BACKGROUND OF THE INVENTION

### Field of the Invention

The present invention relates to a vehicle, and a control apparatus and control method thereof.

### Description of the Related Art

As a function of automated driving and driving support of a vehicle, there is provided a function for the vehicle to change lanes without an operation by a driver. Japanese Patent Laid-Open No. 2016-71513 discloses a technique in which a lane change operation is performed automatically when an automated driving system makes a lane change proposal to a driver and the driver approves the proposed lane change operation.

### SUMMARY OF THE INVENTION

Depending on the travel environment of a vehicle, an automated driving system may be able to automatically execute a lane change operation without requiring approval from the driver. On the other hand, there may be a travel environment in which a lane change operation cannot be proposed by the automated driving system. An aspect of the present invention is to provide a technique to execute a lane change operation according to an automation level depending on the travel environment.

According to an embodiment, a control apparatus of a vehicle, the apparatus comprising: a recognition unit configured to recognize a travel environment of the vehicle; a generation unit configured to generate a travel plan based on the travel environment; and a control unit configured to perform, based on the travel plan, travel control including at least one of acceleration/deceleration and/or steering of the vehicle, wherein in a case in which a lane change operation is to be performed, the control unit decides a lane change difficulty degree or a degree of automation of travel control in the current environment, selects, based on the decided difficulty degree or degree of automation, one lane change mode among a plurality of lane change modes with different degrees of participation by a driver of the vehicle, and performs the travel control in accordance with the selected lane change mode is provided.

### BRIEF DESCRIPTION OF THE DRAWINGS

FIG. 1 is a block diagram for explaining an example of the arrangement of a vehicle according to an embodiment;

FIG. 2 is a schematic view for explaining a control method of a lane change operation according to the embodiment; and

FIG. 3 is a flowchart for explaining the control method of the lane change operation according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

A vehicle 1 includes a vehicle control apparatus 2 (to be simply referred to as the control apparatus 2 hereinafter) that controls the vehicle 1. The control apparatus 2 includes a plurality of ECUs 20 to 29 communicably connected by an in-vehicle network. Each ECU functions as a computer which includes a processor represented by a CPU, a memory such as a semiconductor memory, an interface with an external device, and the like. The memory stores programs to be executed by the processor, data to be used by the processor for processing, and the like. Each ECU may include a plurality of processors, memories, and interfaces. For example, the ECU 20 includes a processor 20a and a memory 20b. Processing by the ECU 20 is executed by the processor 20a executing an instruction included in a program stored in the memory 20b. Alternatively, the ECU 20 may include a dedicated integrated circuit such as an ASIC or the like to execute processing by the ECU 20. Other ECUs may be arranged in a similar manner.

The functions and the like provided by the ECUs 20 to 29 will be described below. Note that the number of ECUs and the provided functions can be appropriately designed, and they can be subdivided or integrated as compared to this embodiment.

The ECU 20 executes control associated with automated driving of the vehicle 1. In automated driving, at least one of steering and/or acceleration/deceleration of the vehicle 1 is automatically controlled. In a control example to be described later, both steering and acceleration/deceleration are automatically controlled.

The ECU 21 controls an electric power steering device 3. The electric power steering device 3 includes a mechanism that steers front wheels in accordance with a driving operation (steering operation) of a driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving, the ECU 21 automatically controls the electric power steering device 3 in correspondence with an instruction from the ECU 20 and controls the direction of travel of the vehicle 1.

The ECUs 22 and 23 perform control of detection units 41 to 43 that detect the peripheral state of the vehicle and information processing of detection results. Each detection unit 41 is a camera (to be sometimes referred to as the camera 41 hereinafter) that captures the front side of the vehicle 1. In this embodiment, the cameras 41 are attached to the windshield inside the vehicle cabin at the front of the roof of the vehicle 1. When images captured by the cameras 41 are analyzed, the contour of a target or a division line (a white line or the like) of a lane on a road can be extracted.

The detection unit 42 is a LIDAR (Light Detection and Ranging) (to be sometimes referred to as the LIDAR 42 hereinafter), and detects a target around the vehicle 1 or measures the distance to a target. In this embodiment, five LIDARs 42 are provided; one at each corner of the front portion of the vehicle 1, one at the center of the rear portion, and one on each side of the rear portion. The detection unit 43 is a millimeter wave radar (to be sometimes referred to as the radar 43 hereinafter), and detects a target around the vehicle 1 or measures the distance to a target. In this embodiment, five radars 43 are provided; one at the center of the front portion of the vehicle 1, one at each corner of the front portion, and one at each corner of the rear portion.

The ECU 22 performs control of one camera 41 and each LIDAR 42 and information processing of detection results. The ECU 23 performs control of the other camera 41 and each radar 43 and information processing of detection results. Since two sets of devices that detect the peripheral state of the vehicle are provided, the reliability of detection results can be improved. In addition, since detection units of different types such as cameras, LIDARs, and radars are provided, the peripheral environment of the vehicle can be analyzed from various aspects.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information and traffic information and acquires these pieces of information. The ECU 24 can access a map information database 24a formed in the storage device. The ECU 24 searches for a route from the current position to the destination. The ECU 24, the map information database 24a, and the GPS sensor 24b form a so-called navigation device.

The ECU 25 includes a communication device 25a for inter-vehicle communication. The communication device 25a performs wireless communication with another vehicle in the periphery and exchanges information between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving, the ECU 26 automatically controls the power plant 6 in correspondence with an instruction from the ECU 20 and controls the acceleration/deceleration of the vehicle 1.

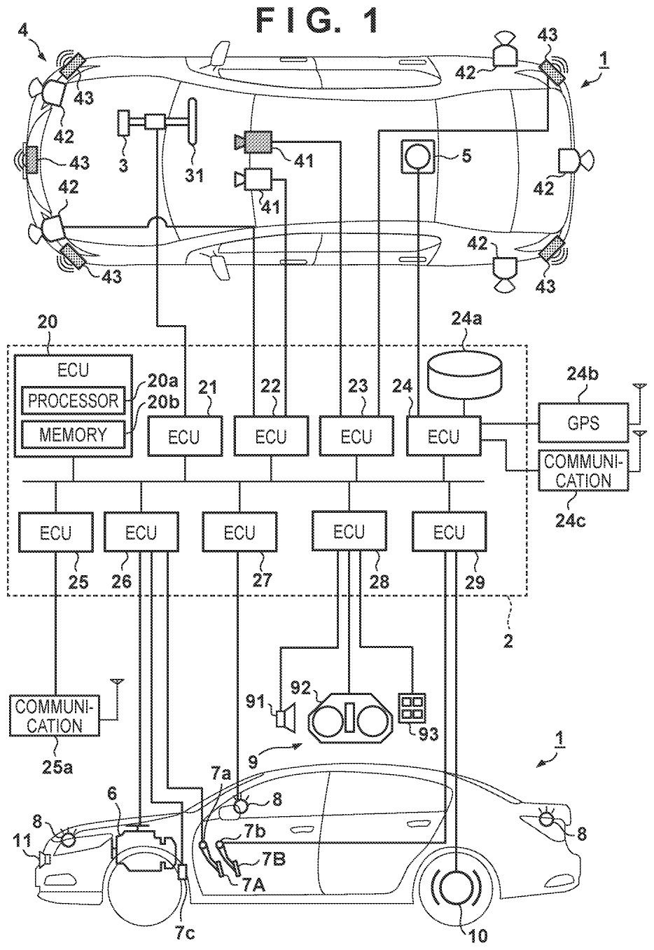

The ECU 27 controls lighting devices 8 (lighting instruments such as headlights, taillights, and the like) including direction indicators (turn signals). In the example shown in FIG. 1, the lighting devices 8 are provided in the front portion, door mirrors, and the rear portion of the vehicle 1. The ECU 27 further includes a sound device 11 including a horn or the like directed to the outside of the vehicle. The lighting devices 8, the sound device 11, or a combination of them has a function of providing information to the outside of the vehicle 1.

The ECU 28 controls an input/output device 9. The input/output device 9 outputs information to the driver and accepts input of information from the driver. A voice output device 91 notifies the driver of the information by voice. A display device 92 notifies the driver of information by displaying an image. The display device 92 is arranged, for example, in front of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified. An input device 93 is a switch group that is arranged in a position where the driver can perform an operation, is used to issue an instruction to the vehicle 1, and may also include a voice input device. The ECU 28 can perform a guidance operation related to the travel control by the ECU 20. The details of the guidance operation will be described later. The input device 93 can include a switch used to control the travel control operation by the ECU 20. The input device 93 can include a camera for detecting the direction of the line of sight of the driver.

The ECU 29 controls a brake device 10 and a parking brake (not shown). The brake device 10 is, for example, a disc brake device which is provided for each wheel of the vehicle 1 and decelerates or stops the vehicle 1 by applying resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving, the ECU 29 automatically controls the brake device 10 in correspondence with an instruction from the ECU 20 and controls deceleration and stop of the vehicle 1. The brake device 10 or the parking brake can also be operated to maintain the stop state of the vehicle 1. In addition, if the transmission of the power plant 6 includes a parking lock mechanism, it can be operated to maintain the stop state of the vehicle 1.

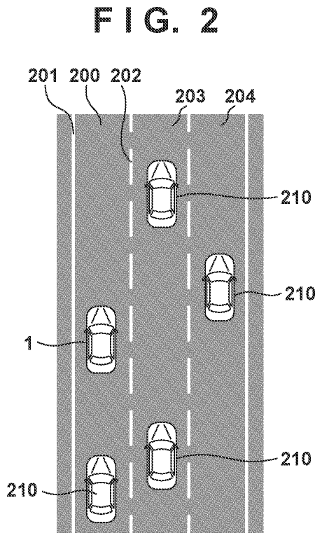

The outline of a lane change operation executed by the ECU 20 will be described with reference to FIG. 2. The vehicle 1 is traveling on a lane 200. That is, the lane 200 is the travel lane. The lane 200 is defined by a left-side division line 201 (for example, the left-side line of the road) and a right-side division line 202 (for example, the lane boundary line). A lane 203 is adjacent to the right side of the lane 200, and a lane 204 is adjacent to the right side of the lane 203. Vehicles 210 other than the vehicle 1 are traveling on the lanes 200, 203, and 204.

The ECU 20 generates a travel plan based on the travel environment of the vehicle 1 recognized by the detection units 41 to 43, and executes a lane change operation autonomously or under the driver's instruction to implement the travel plan. For example, this lane change operation is an operation to move the vehicle 1 from the lane 200 to the lane 203. In order to execute the lane change operation, the ECU 20 may perform travel control which includes both the acceleration/deceleration and the steering of the vehicle 1.

The ECU 20 will select one lane change mode from a plurality of lane change modes that have different degrees of participation by the driver of the vehicle 1, and perform travel control under this selected lane change mode. The lane change mode will be simply referred to as a change mode hereinafter. A plurality of change modes that have different degrees of participation by the driver of the vehicle 1 can also be called a plurality of change modes that have different automation levels. The automation level increases as the degree of participation by the driver decreases, and the automation level decreases as the degree of participation by the driver increases.

For example, the plurality of change modes can include the following three change modes. The first change mode is a change mode in which the driver of the vehicle 1 plans the lane change operation and the driver of the vehicle 1 issues an instruction to start the lane change operation. In this lane change mode, the driver of the vehicle 1 will consider the state of travel and the route to the destination, and determine whether a lane change operation needs to be performed. Subsequently, if a lane change operation needs to be performed, the driver of the vehicle 1 will instruct the vehicle 1 to start the lane change operation at a timing at which the lane change operation can be executed. The ECU 20 will start the lane change operation in response to this instruction.

The second change mode is a change mode in which the ECU 20 plans the lane change operation and the driver of the vehicle 1 issues the instruction to start the lane change operation. In this change mode, the ECU 20 will consider the state of travel and the route to the destination, and determine whether a lane change operation needs to be performed. If a lane change operation needs to be performed, the ECU 20 will make a lane change proposal to the driver. The driver of the vehicle 1 will consider the state of travel in response to this lane change proposal, and instruct the vehicle 1 to start the lane change operation at a timing in which the lane change operation can be executed. The ECU 20 will start the lane change operation in response to this instruction.

The third change mode is a change mode in which the ECU 20 plans the lane change operation and the start of the lane change operation is decided by the ECU 20. In this change mode, the ECU 20 will consider the state of travel and the route to the destination, and determine whether a lane change operation needs to be performed. If a lane change operation needs to be performed, the ECU 20 will consider the state of travel and start the lane change operation at a timing in which the lane change operation can be executed. The driver of the vehicle 1 may be able to issue an instruction to cancel this lane change operation.

Among the three change modes described above, the first change mode has the lowest automation level (that is, the highest degree of participation by the driver), and the third change mode has the highest automation level (that is, the lowest degree of participation by the driver). The change mode that can be selected by the ECU 20 is not limited to the three change modes described above. For example, the ECU 20 may select a mode in which the driver of the vehicle 1 plans the lane change operation, and the start of the lane change operation is decided by the ECU 20. Furthermore, it may be set so some of the three change modes described above cannot be selected. For example, the ECU 20 may select one of the first change mode and the second change mode or select one of the second change mode and the third change mode.

The ECU 20 decides the degree of difficulty in executing the lane change operation in the current travel environment, and selects one change mode among the plurality of change modes based on this degree of difficulty. The degree of difficulty in executing the lane change operation will be simply referred to as the change difficulty degree hereinafter. More specifically, the ECU 20 will select a change mode with a low automation level as the change difficulty degree increases, and select a change mode with a high automation level as the change difficulty degree decreases. In a case in which a change mode is to be selected from the three change modes as described above, the ECU 20 will evaluate the change difficulty degree at three levels. The ECU 20 will select a change mode with the lowest automation level when the change difficulty degree is at the highest level, select a change mode with the highest automation level when the change difficulty degree is at the lowest level, and select a change mode with the intermediate automation level when the change difficulty degree is at the intermediate level.

For example, the ECU 20 can decide the change difficulty degree based on at least one of the number of lanes, the presence/absence of a shoulder, the presence/absence of a median strip, the designated speed limit, the type of division lines (202), the division line detection state, the road width, the information related to the map, the curvature of the lane, the past travel history of the vehicle 1, and/or the past lane change history of the vehicle 1. For example, the ECU 20 can decrease the change difficulty degree in a case in which there is a small number of lanes on the road including the current travel lane 200, and increase the change difficulty degree in a case in which there is a large number of lanes. The ECU 20 can decrease the change difficulty degree in a case in which the shoulder is present in the road including the current travel lane 200, and increase the change difficulty degree in a case in which the shoulder is absent from the road. The ECU 20 can decrease the change difficulty degree in a case in which the median strip is present in the road including the current travel lane 200, and increase the change difficulty degree in a case in which the median strip is absent from the road. The ECU 20 can decrease the change difficulty degree in a case in which the designated speed limit designated by a road sign or the like is high, and increase the change difficulty degree in a case in which the designated speed limit is low. The ECU 20 can decrease the change difficulty degree in a case in which the division line between the current travel lane 200 and the lane change destination lane 203 is a normal broken line, and increase the change difficulty degree in a case in which the division line is a boundary line with a parallel dotted line. The ECU 20 can decrease the change difficulty degree in a case in which the right-side division line 202 between the current travel lane 200 and the lane change destination lane 203 can be clearly detected, and increase the change difficulty degree in a case in which the division line cannot be clearly detected. The ECU 20 can decrease the change difficulty degree in a case in which the road width of the lane 200 and/or the lane 203 is wider than a threshold, and increase the change difficulty degree in a case in which the road width is narrower than the threshold. The ECU 20 can decrease the change difficulty degree in a case in which a map of the current travel position can be obtained, and increase the change difficulty degree in a case in which this map cannot be obtained. The ECU 20 can decrease the change difficulty degree in a case in which the clarity of the map of the current travel position is high, and increase the change difficulty degree in a case in which the clarity of this map is low. The ECU 20 can decrease the change difficulty degree in a case in which the curvature of the current travel lane 200 is small or increase the change difficulty degree in a case in which the curvature is large. The ECU 20 can, by referring to the past travel history of the vehicle 1, decrease the change difficulty degree in a case in which the vehicle 1 has traveled the current travel lane in the past and increase the change difficulty degree in a case in which the vehicle 1 has not traveled the current travel lane in the past. The ECU 20 can, by referring to the past lane change history of the vehicle 1, decrease the change difficulty degree in a case in which the past lane change count is high and increase the change difficulty degree in a case in which the past lane change count is low.

Alternatively or in addition to this, the ECU 20 may also decide the change difficulty degree based on at least one of the vehicle type of each vehicle 210 traveling in the periphery of the vehicle 1, the number of vehicles 210 traveling in the periphery of the vehicle 1, the positional relationship between the vehicles 210 traveling in the periphery of the vehicle 1, and/or the travel stability of the vehicles 210 traveling in the periphery of the vehicle 1. For example, the ECU 20 can decrease the change difficulty degree in a case in which the vehicle type of each vehicle 210 traveling in the periphery is a small vehicle and increase the change difficulty degree in a case in which the vehicle type is a large vehicle. The ECU 20 can decrease the change difficulty degree in a case in which a small number of vehicles 210 are traveling in the periphery, and increase the change difficulty degree in a case in which a large number of vehicles 210 are traveling in the periphery. The ECU 20 can decrease the change difficulty degree in a case in which the vehicles 210 traveling in the periphery are far from the vehicle 1 and increase the change difficulty degree in a case in which the vehicles 210 traveling in the periphery are close to the vehicle 1. The ECU 20 can decrease the change difficulty degree in a case in which the travel stability of the vehicles 210 traveling in the periphery is high (for example, the peripheral vehicles are traveling at constant velocity) and increase the change difficulty degree in a case in which this stability is low (for example, the peripheral vehicles are accelerating/decelerating).

Alternatively or in addition to this, the ECU 20 can decide the change difficulty degree based on the legal speed limit of the lane(s) (for example, the current travel lane 200 and/or the lane change destination lane 203) related to the lane change operation. For example, the ECU 20 can decrease the change difficulty degree in a case in which the legal speed limit is high, and increase the change difficulty degree in a case in which the legal speed limit is low. The legal speed limit is the speed limit set to each road by law. For example, the legal speed limit includes the maximum speed limit (also referred to as the highest speed limit) and the designated speed limit. The maximum speed limit is the maximum value of permitted speed in a case in which the speed is not designated by a road sign or the like. The maximum speed limit of a general road is 60 km/h, and the maximum speed limit of an express way is 100 km/h. The designated speed is the maximum value of permitted speed designated individually to each road by a road sign or the like. The ECU 20 controls the vehicle to travel at a speed equal to or less than the maximum speed limit on a road to which a designated speed limit has not been set, and travel at a speed equal to or less than the designated speed limit on a road to which a designated speed limit has been set. Also, in a case in which the driver has set the maximum value of the travel speed, the ECU 20 controls the vehicle to travel at a speed which is equal to or less than the set speed limit and is equal to or less than the legal speed limit. The set speed limit may be set by using traffic sign information and map information.

Alternatively or in addition to this, the ECU 20 can decide the change difficulty degree based on at least one of the speed of the vehicle 1 and/or the speeds of the vehicles 210 traveling in the periphery of the vehicle 1. For example, the ECU 20 can decrease the change difficulty degree in a case in which the speed of the vehicle 1 is high and increase the change difficulty degree in a case in which the speed of the vehicle 1 is low. The ECU 20 can also decrease the change difficulty degree in a case in which the speeds of the vehicles 210 in the periphery are low, and increase the change difficulty degree in a case in which the speeds of the vehicle 210 in the periphery is high.

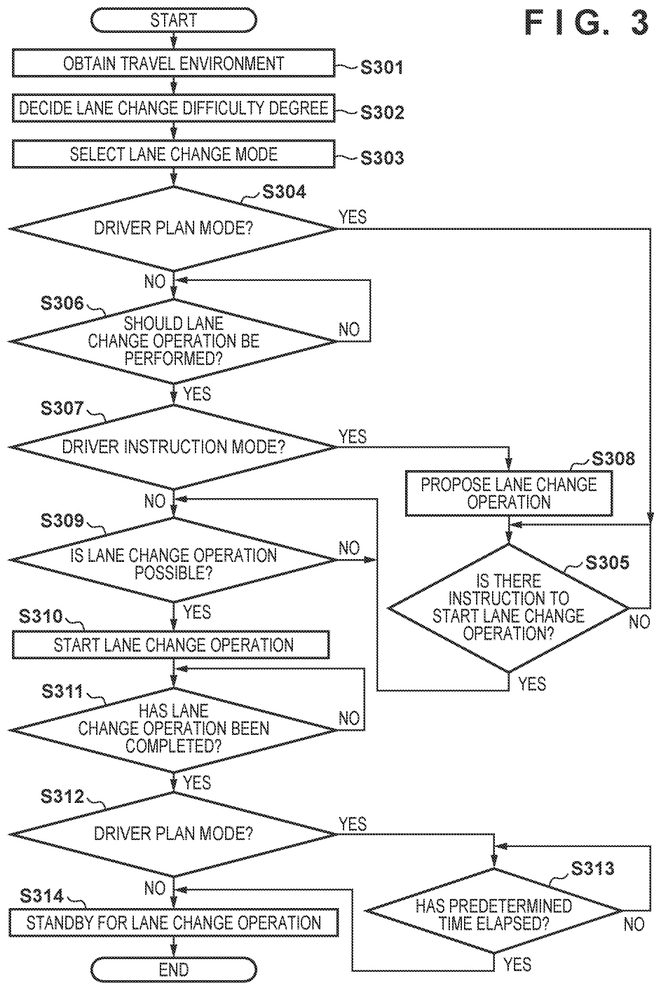

A control method of the vehicle 1 to perform a lane change operation will be described with reference to FIG. 3. In this control method, the control apparatus (more specifically, the ECU 20) of the vehicle 1 selects one change mode among a plurality of change modes based on the change difficulty degree, and executes travel control to perform a lane change operation in accordance with the selected change mode. The control method of FIG. 3 may be performed by the processor 20a of the ECU 20 executing a program stored in the memory 20b. Alternatively, some or all of the processes of this method may be executed by a dedicated circuit such as an ASIC (Application Specific Integrated Circuit). In the case of the former, the processor 20a will be the component for a specific operation, and in the case of the latter, the dedicated circuit will be the component for a specific operation. The control method of FIG. 3 is executed repeatedly while travel control by automated traveling is executed by the ECU 20.

In step S301, the ECU 20 obtains information of the current travel environment of the vehicle 1 recognized by the detection units 41 to 43. This information of the travel environment may include the state (the speed and the like) of the vehicle 1, the peripheral environment (the state of the division line 201 and the like), and the state of each peripheral vehicle (the speed and the position of each peripheral vehicle). Although the information of the current travel environment is obtained in step S301 in the example of FIG. 3, the obtainment of the information of the current travel environment will be performed repeatedly while the control method of FIG. 3 is executed.

In step S302, the ECU 20 decides the change difficulty degree of the current environment based on the information obtained in step S301. The method of deciding the change difficulty degree is as described above.

In step S303, the ECU 20 selects, from the plurality of change modes, a change mode based on the change difficulty degree decided in step S302. As described above, the higher the change difficulty degree, the ECU 20 will select a change mode with a higher degree of driver participation (that is, with a lower automation level), and the lower the change difficulty degree, the ECU 20 will select a change mode with a lower degree of driver participation (that is, with a higher automation level).

In step S304, the ECU 20 determines whether the change mode selected in step S303 is a change mode in which the lane change operation is planned by the driver. If the selected change mode is a change mode in which the lane change operation is planned by the driver (YES in step S304), the ECU 20 shifts the process to step S305. Otherwise (NO in step S304), the process shifts to step S306.

In step S305, the ECU 20 determines whether the driver has issued an instruction to start the lane change operation. If the driver has issued a start instruction (YES in step S305), the ECU 20 shifts the process to step S309. Otherwise (NO in step S305), the process of step S305 is repeated. The process of step S305 is performed in the case of a change mode (that is the first change mode described above) in which the driver of the vehicle 1 plans the lane change operation. In this change mode, the driver of the vehicle 1 issues an instruction to start the lane change operation. Hence, the ECU 20 will wait until the driver issues the instruction to start the lane change operation.

In step S306, the ECU 20 determines, based on the current travel environment, whether a lane change operation should be performed. If the lane change operation should be performed (YES in step S306), the ECU 20 shifts the process to step S307. Otherwise (NO in step S306), the process of step S306 is repeated. The process of step S306 is performed in the case of a change mode (the second change mode or the third change mode described above) in which the lane change operation is planned by the ECU 20. Hence, the ECU 20 will consider the state of travel (for example, a case in which the vehicle is to pass a preceding vehicle) and the route to the destination, and wait until the state changes to a state in which the lane change operation should be executed.

In step S307, the ECU 20 determines whether the change mode selected in step S303 is a change mode in which the driver issues a lane change start instruction. If the selected change mode is a change mode in which the driver issues the lane change start instruction (YES in step S307), the ECU 20 shifts the process to step S308. Otherwise (NO in step S307), the process shifts to step S309.

In step S308, the ECU 20 makes a lane change proposal to the driver. The process of step S308 is performed in the case of a change mode (the second change mode described above) in which the ECU 20 plans a lane change operation and the driver of the vehicle 1 issues a lane change start instruction. Hence, in order to obtain a lane change operation instruction from the driver, the ECU 20 will make a lane change proposal to the driver. Subsequently, by executing the process of step S305 described above, the ECU 20 will wait until an instruction is input from the driver.

In step S309, the ECU 20 determines, based on the current travel environment, whether a lane change operation can be executed. If the lane change operation can be executed (YES in step S309), the ECU 20 shifts the process to step S310. Otherwise (NO in step S309), the process of step S309 is repeated. The process of step S309 is performed in any of the first to third change modes described above.

In step S310, the ECU 20 starts the lane change operation. The process of step S310 is executed in a case in which the driver has issued the lane change start instruction in step S305 or in a case in which the ECU 20 has determined that the lane change operation can be executed in step S309.

In step S311, the ECU 20 determines whether the lane change operation has been completed. If the lane change operation has been completed (YES in step S311), the ECU 20 shifts the process to step S312. Otherwise (NO in step S311), the process of step S311 is repeated. That is, the ECU 20 will wait until the lane change operation has been completed. For example, the ECU 20 may determine that the lane change operation has been completed when the vehicle 1 has moved to the vicinity of the lane center of the adjacent lane (the lane change destination lane), or may determine that the lane change operation has been completed when the vehicle 1 has crossed the division line between the current travel lane and the adjacent lane by a predetermined ratio or more. In parallel to this process, the ECU 20 executes travel control to perform the lane change operation.

In step S312, the ECU 20 determines whether the change mode selected in step S303 is a change mode in which a lane change start instruction is issued by the driver. If the selected change mode is a change mode in which the lane change start instruction is issued by the driver (YES in step S312), the ECU 20 shifts the process to step S313. Otherwise (NO in step S312), the process shifts to step S314.

In step S313, the ECU 20 determines whether a predetermined time has elapsed or the vehicle 1 has traveled a predetermined distance after the completion of the lane change operation. If the predetermined time has elapsed or the vehicle 1 has traveled the predetermined distance (YES in step S313), the ECU 20 shifts the process to step S314. Otherwise (NO in step S313), the process of step S313 is repeated.

In step S314, ECU 20 stands by for an additional lane change operation. In a case in which the change mode selected in step S303 is a change mode in which the lane change start instruction is issued by the driver, the process of step S314 will be executed after the execution of the process of step S313. The change mode in which the driver issues the lane change start instruction is selected in a case in which the change difficulty degree of the travel environment is high. In such a travel environment, it is highly difficult to perform a lane change operation continuously in a short period. Thus, the ECU 20 will suppress the execution of an additional lane change operation until a predetermined time has elapsed or until a predetermined distance has been traveled. On the other hand, in a case in which the change mode selected in step S303 is the change mode in which the lane change operation is planned by the ECU 20, the process of step S314 will be executed without executing the process of step S313. The change mode in which the ECU 20 plans the lane change operation is selected in the case of a travel environment with an intermediate or low change difficulty degree. Thus, the ECU 20 will allow the execution of an additional lane change operation even before (and also after) the predetermined time has elapsed or the predetermined distance has been traveled.

In the above-described control method of FIG. 3, processing steps are added or omitted appropriately in accordance with the change mode that can be selected by the ECU 20. For example, the process of step S304 will be omitted in a case in which the above-describe first change mode is to be removed as a selection candidate. Also, in step S312, the ECU 20 determined whether the change mode selected in step S303 is the change mode in which the lane change start instruction is issued by the driver. Alternatively, the ECU 20 may determine whether the change mode selected in step S303 is the change mode in the lane change start instruction is issued by the driver.

In addition, in a case in which travel control is to be performed based on a travel plan with a set destination, the ECU 20 can prioritize and select a change mode with less participation by the driver of the vehicle 1 compared to that of a case in which travel control is to be performed based on a travel plan without a set destination. For example, the ECU 20 may select one of the second change mode and the third change mode described above in a case in which travel control is to be performed based on a travel plan with a set destination, and select the first change mode in a case in which travel control is to be performed based on a travel plan without a set destination. Alternatively, in a case in which travel control is to be performed based on a travel plan with a set destination, the ECU 20 may perform the change mode selection in step S303 after reducing the change difficulty degree decided in step S302.

Alternatively, instead of the processes of steps S312 to S314 described above, the ECU 20 may allow the execution of an additional lane change operation if the automation level of the travel control is set to a level in which control is led by the driver (for example, a level in which a periphery monitoring duty is imposed on the driver) or suppress the execution of an additional lane change operation if the automation level of the travel control is set to a level in which control is led by the system (for example, a level in which the periphery monitoring duty is not imposed on the driver). This ensures safety because it is possible to respect the driver's intention as well as suppress a lane change operation in a case in which a high-risk phenomenon is predicted.

Alternatively or in addition to the processes of steps S302 and S303 described above, the ECU 20 may decide the automation level of the travel control to be performed in the current travel environment, and select one lane change mode among the plurality of lane change modes based on the decided automation level. An upper limit is set to the automation level based on the current travel environment. In a case in which the driver does not make a designation, the ECU 20 may perform travel control at the upper-limit automation level. In a case in which the driver has designated a level lower than the upper limit, the ECU 20 may perform travel control corresponding to the automation level designated by the driver. In case in which the automation level is set at a level in which the duty to grip the steering wheel is imposed on the driver, the ECU 20 may select the change mode (the first change mode described above) in which the driver of the vehicle 1 plans the lane change operation and the driver of the vehicle 1 issues the lane change start instruction. In a case in which the automation level is set at a level in which the duty to grip the steering wheel is not imposed, but the duty to monitor the periphery is imposed on the driver, the ECU 20 may select the change mode (the second change mode described above) in which the ECU 20 plans the lane change operation and the driver of the vehicle 1 issues the lane change start instruction. In a case in which the automation level is set at a level in which the periphery monitoring duty is not imposed on the driver, the ECU 20 may select the change mode (the third change mode described above) in which the ECU 20 plans the lane change operation and the ECU 20 decides the start of the lane change operation.

### Summary of Embodiment

<Arrangement 1>

There is provided a control apparatus (2) of a vehicle (1), the apparatus comprising:

a recognition unit (41-43) configured to recognize a travel environment of the vehicle;

a generation unit (20) configured to generate a travel plan based on the travel environment; and

a control unit (20) configured to perform, based on the travel plan, travel control including at least one of acceleration/deceleration and/or steering of the vehicle,

wherein in a case in which a lane change operation is to be performed, the control unit

decides a lane change difficulty degree or a degree of automation of travel control in the current environment,

selects, based on the decided difficulty degree or degree of automation, one lane change mode among a plurality of lane change modes with different degrees of participation by a driver of the vehicle, and

performs the travel control in accordance with the selected lane change mode.

According to this arrangement, it is possible to perform a lane change operation at an automaton level corresponding to the travel environment. For example, it is possible to execute a lane change operation at an alternative automation level permitted by the lane change difficulty degree.

<Arrangement 2>

There is provided the apparatus according to arrangement 1, wherein the plurality of lane change modes include a mode in which the driver of the vehicle plans the lane change operation, and a mode in which the control unit plans the lane change operation.

According to this arrangement, it is possible to select one lane change mode among a plurality of lane change modes with different main constituents that plan the lane change operation.

<Arrangement 3>

There is provided the apparatus according to arrangement 1 or 2, wherein the plurality of lane change modes include

a mode in which the driver of the vehicle issues an instruction to start the lane change operation, and

a mode in which the control unit decides the start of the lane change operation.

According to this arrangement, it is possible to select one lane change mode among a plurality of lane change modes with different main constituents that decide the start timing of the lane change operation.

<Arrangement 4>

There is provided the apparatus according to arrangement 1, wherein the plurality of lane change modes include

a mode in which the driver of the vehicle plans the lane change operation and the driver of the vehicle issues an instruction to start the lane change operation,

a mode in which the control unit plans the lane change operation and the driver of the vehicle issues the instruction to start the lane change operation, and

a mode in which the control unit plans the lane change operation and the control unit decides the start of the lane change operation.

According to this arrangement, it is possible to select one lane change mode among a plurality of lane change modes with different main constituents that plan the lane change operation and/or different main constituents that decide the start timing of the lane change operation.

<Arrangement 5>

There is provided the apparatus according to any one of arrangements 1 to 4, wherein the control unit decides the lane change difficulty degree based on at least one of the number of lanes, presence/absence of a shoulder, presence/absence of a median strip, designated speed limit, type of division line (202), division line detection state, road width, information related to a map, curvature of a lane (200, 203), past travel history of the vehicle, and/or past lane change history of the vehicle.

According to this arrangement, the difficulty degree can be decided based on information related to the road and information related to the vehicle.

<Arrangement 6>

There is provided the apparatus according to any of arrangements 1 to 5, wherein the control unit decides the lane change difficulty degree based on at least one of the type of a vehicle (210) traveling in the periphery of a self-vehicle, number of vehicles (210) traveling in the periphery of the self-vehicle, positional relationship between the vehicles (210) traveling in the periphery of the self-vehicle, and/or travel stability of the vehicles (210) traveling in the periphery of the self-vehicle.

According to this arrangement, the difficulty degree can be decided based on information related to a vehicle traveling in the periphery.

<Arrangement 7>

There is provided the apparatus according to any one of arrangements 1 to 6, wherein the control unit decides the lane change difficulty degree based on a legal speed limit of a lane (200, 203) related to the lane change operation.

According to this arrangement, the difficulty degree can be decided based on information related to the legal speed limit.

<Arrangement 8>

There is provided the apparatus according to any one of arrangements 1 to 7, wherein the control unit decides the lane change difficulty degree based on at least one of the speed of a self-vehicle and/or the speed of a vehicle (210) traveling in the periphery of the self-vehicle.

According to this arrangement, the difficulty degree can be decided based on information related to the actual speed.

<Arrangement 9>

There is provided the apparatus according to any one of arrangements 1 to 8, wherein until a predetermined time has elapsed or a predetermined distance has been traveled since the completion of the lane change operation, the control unit

suppresses execution of an additional lane change operation in a case which the completed lane change operation is a lane change operation according to a mode in which the driver of the vehicle plans the lane change operation, and

allows execution of the additional lane change operation in a case which the completed lane change operation is a lane change operation according to a mode in which the control unit plans the lane change operation.

According to this arrangement, it is possible to avoid continuous execution of the lane change operation in an environment with a high lane change difficulty degree.

<Arrangement 10>

There is provided the apparatus according to any one of arrangements 1 to 9, wherein the control unit prioritizes a lane change mode which has a low degree of participation by the driver of the vehicle in a case in which the travel control is to be performed based on a travel plan with a set destination, compared with a case in which the travel control is to be performed based on a travel plan without a set destination.

According to this arrangement, the automation level can be improved in the case of a travel plan with a set destination.

<Arrangement 11>

There is provided a vehicle (1) comprising a control apparatus defined in any one of arrangements 1 to 10.

According to this arrangement, it is possible to provide a vehicle that includes a control apparatus described above.

<Arrangement 12>

There is provided a control method of a vehicle (1), the method comprising:

recognizing (S301) a travel environment of the vehicle;

generating a travel plan based on the travel environment; and

performing (S302-S314), based on the travel plan, travel control including at least one of acceleration/deceleration and/or steering of the vehicle,

wherein in a case in which a lane change operation is to be performed in the travel control,

a lane change difficulty degree or a degree of automation of travel control in the current environment is decided (S302),

one lane change mode among a plurality of lane change modes with different degrees of participation by a driver of the vehicle is selected (S303) based on the decided difficulty degree or degree of automation, and

the travel control is performed (S304-S314) in accordance with the selected lane change mode.

According to this arrangement, it is possible to perform a lane change operation at an automaton level corresponding to the travel environment.

<Arrangement 13>

There is provided a non-transitory storage medium storing a program that causes a computer to function as each unit of a control apparatus defined in any one of arrangements 1 to 10.

According to this arrangement, it is possible to provide a program to generate a control apparatus described above.

The invention is not limited to the foregoing embodiments, and various variations/changes are possible within the spirit of the invention.

What is claimed is:

1. A control apparatus of a vehicle, the apparatus comprising:
a recognition unit configured to recognize a travel environment of the vehicle;
a generation unit configured to generate a travel plan based on the travel environment; and
a control unit configured to perform, based on the travel plan, travel control including at least one of acceleration/deceleration and/or steering of the vehicle,
wherein in a case in which a lane change operation is to be performed, the control unit
decides a lane change difficulty degree or a degree of automation of travel control in the current environment,
selects, based on the decided difficulty degree or degree of automation, one lane change mode among a plurality of lane change modes with different degrees of participation by a driver of the vehicle, and
performs the travel control in accordance with the selected lane change mode.

2. The apparatus according to claim 1, wherein the plurality of lane change modes include
a mode in which the driver of the vehicle plans the lane change operation, and
a mode in which the control unit plans the lane change operation.

3. The apparatus according to claim 1, wherein the plurality of lane change modes include
a mode in which the driver of the vehicle issues an instruction to start the lane change operation, and
a mode in which the control unit decides the start of the lane change operation.

4. The apparatus according to claim 1, wherein the plurality of lane change modes include
a mode in which the driver of the vehicle plans the lane change operation and the driver of the vehicle issues an instruction to start the lane change operation,
a mode in which the control unit plans the lane change operation and the driver of the vehicle issues the instruction to start the lane change operation, and
a mode in which the control unit plans the lane change operation and the control unit decides the start of the lane change operation.

5. The apparatus according to claim 1, wherein the control unit decides the lane change difficulty degree based on at least one of the number of lanes, presence/absence of a shoulder, presence/absence of a median strip, designated speed limit, type of division line, division line detection state, road width, information related to a map, curvature of a lane, past travel history of the vehicle, and/or past lane change history of the vehicle.

6. The apparatus according to claim 1, wherein the control unit decides the lane change difficulty degree based on at least one of the type of a vehicle traveling in the periphery of a self-vehicle, number of vehicles traveling in the periphery of the self-vehicle, positional relationship between the vehicles traveling in the periphery of the self-vehicle, and/or travel stability of the vehicles traveling in the periphery of the self-vehicle.

7. The apparatus according to claim 1, wherein the control unit decides the lane change difficulty degree based on a legal speed limit of a lane related to the lane change operation.

8. The apparatus according to claim 1, wherein the control unit decides the lane change difficulty degree based on at least one of the speed of a self-vehicle and/or the speed of a vehicle traveling in the periphery of the self-vehicle.

9. The apparatus according to claim 1, wherein until a predetermined time has elapsed or a predetermined distance has been traveled since the completion of the lane change operation, the control unit
suppresses execution of an additional lane change operation in a case which the completed lane change operation is a lane change operation according to a mode in which the driver of the vehicle plans the lane change operation, and
allows execution of the additional lane change operation in a case which the completed lane change operation is a lane change operation according to a mode in which the control unit plans the lane change operation.

10. The apparatus according to claim 1, wherein the control unit prioritizes a lane change mode which has a low degree of participation by the driver of the vehicle in a case in which the travel control is to be performed based on a travel plan with a set destination, compared with a case in which the travel control is to be performed based on a travel plan without a set destination.

11. A vehicle comprising a control apparatus defined in claim 1.

12. A control method of a vehicle, the method comprising:
recognizing a travel environment of the vehicle;
generating a travel plan based on the travel environment; and
performing, based on the travel plan, travel control including at least one of acceleration/deceleration and/or steering of the vehicle,
wherein in a case in which a lane change operation is to be performed in the travel control,
a lane change difficulty degree or a degree of automation of travel control in the current environment is decided,
one lane change mode among a plurality of lane change modes with different degrees of participation by a driver of the vehicle is selected based on the decided difficulty degree or degree of automation, and
the travel control is performed in accordance with the selected lane change mode.

13. A non-transitory storage medium including a program that causes a computer to function as each unit of a control apparatus defined in claim 1.
